(19) United States
(12) Patent Application Publication
(10) Pub. No.: US 2009/0235602 A1
(43) Pub. Date: Sep. 24, 2009

(54) Strengthened shutter system

(76) Inventor: David H. Ceccofiglio, Pompano Beach, FL (US)

Correspondence Address: GrayRobinson, P. A., 401 E. LAS OLAS BLVD, SUITE 1850, FORT LAUDERDALE, FL, 33301, US

(21) Appl. No.: 12/077,884

(22) Filed: Mar. 21, 2008

(51) Int. Cl. E06B 7/08

(52) U.S. Cl. 52/473

(57) ABSTRACT

An improved shutter system for covering an opening in a wall of a building provides a barrier assembly that reduces likelihood of slat dislodgement. The shutter system includes a mounting assembly having at least one pair of guide tracks, and a barrier assembly having a plurality of interlocking flexible slats and at least one slat retention plug. The slat retention plug is retainingly engaged to an end of one of the slats of the barrier assembly by at least one retention tab in a wall of one of the slats. The slat retention plug is adapted to be slidingly engaged within one of guide channels of inner surfaces of the guide tracks. The slat retention plug defines a shoulder engaging at least one stop member of at least one of inner surfaces of the guide tracks upon deflection of the slats.

### FIELD OF THE INVENTION

The present invention relates generally to shutter systems for covering openings in walls of buildings and, more particularly, to a strengthened retractable/deployable shutter system and barrier assembly for use in connection therewith that utilizes a combination of interlocking slats and interlocking connecting members having recesses to assist in retaining the slats in associated guide rails when displacement forces are exerted upon the slats.

### BACKGROUND OF THE INVENTION

Shutter systems are well known. Such systems are typically used on an as-needed basis to cover and protect windows, doors, and other openings in buildings from flying debris and other displacement forces that result from strong storms, such as severe thunderstorms, hurricanes, tropical storms, typhoons, and tropical cyclones. Such systems may also be used on a more regular basis (e.g., daily) to provide privacy, noise reduction, and security or intrusion resistance.

Basic shutter systems include a barrier assembly made up of corrugated steel or aluminum alloy panels that are fastened over the wall openings using threaded bolts that screw into anchors recessed in the walls of the building. Other basic systems also use corrugated panels, but instead of recessed anchors, such systems use rails that are secured to the building above and below the opening. The panels are inserted along the rails and are secured to the rails with bolts and wing nuts.

While storm panels are useful in protecting the building's openings, they have certain disadvantages. For example, steel panels are relatively heavy, weighing approximately two pounds per square foot. Thus, such panels become difficult to install on a two or three story dwelling, particularly when the homeowner must carry each panel necessary to cover the upper story windows up a ladder and onto a roof. Making the upper story installation even more difficult is the common use of wavy, Spanish tile roofs on many homes in geographical areas that are more prone to be in the paths of hurricanes or other strong storms.

Other more sophisticated storm shutter systems are also commercially available. One such system is referred to as an accordion shutter system. In an accordion shutter system, rails are installed above and below the wall opening, and a flexible, corrugated panel is permanently installed just outside each vertical end of the opening such that the panels, when deployed, can slide in the track created by the rails. When not in use, the panels are in a collapsed or compressed state and reside adjacent the vertical ends of the opening. To use, the user manually pulls or deploys each panel toward the center of the opening and locks the two panels together with a small padlock or other locking mechanism to keep them in place. When the storm has passed or use is otherwise no longer necessary or desired, the lock is removed and the user manually pushes or retracts the panels into their collapsed positions adjacent the vertical ends of the opening. Since the accordion panels are permanently installed, they need not be physically carried to and from their intended location before and after use.

Another more sophisticated shutter system is commonly referred to as a roller system or a rolling shutter system. In this system, the panels and anchors or rails of basic and accordion systems are replaced with a different barrier assembly made up of a series of interlocking steel or aluminum alloy slats that are wound around a motorized roller tube or reel. The roller tube resides in a housing that is mounted to or within the building just above the opening to be protected. Guide tracks are also mounted on each vertical sidewall of the opening to be covered to guide the movement of the slats during deployment and retraction.

The motor of the rolling shutter system is electrically controlled and deploys the slats to cover the building's opening upon activation thereof. The deployment or lowering of the rolling shutter is based on the free fall of the interlocked slats primarily from the force of gravity while the roller tube rotates in one direction. Subsequent activation of the motor causes the motor to rotate the roller tube in an opposite direction to retract the slats and restore them on the roller tube. A motorized roller and its associated housing are permanently installed above whichever opening(s) are to be covered by the system. Dependable operation of the rolling shutter system relies on the ability of the slats to freely travel in the guide tracks without obstruction from pins, stems, or any other integrated components of the tracks.

While rolling shutter systems are very convenient forms of storm protection and security, they have their limitations. For example, the exertion of sufficiently strong displacement forces against the slats can cause the slats to deflect or bow excessively and thereby dislodge from the guide tracks, exposing the wall opening to flying debris or an intruder.

Various approaches have been proposed in order to try to prevent such dislodgement of the slats. One such approach is disclosed in U.S. Pat. No. 5,839,493 issued to Quasius. Quasius describes a rolling shutter and retention assembly in which stop elements are inserted into the ends of the shutter slats and the guide tracks include angled retention surfaces. When the slats are bowed as a result of displacement forces, the stop elements (e.g., screws or nails) engage the retention surfaces of the guide tracks to prevent or substantially impede dislodgement of the slats. While the Quasius system includes the use of a slat retention stop element 54, it requires a reinforcement bar 26 to be press fit within the corresponding slat to which the stop member is to be connected, and the stop member then driven into an aperture defined by the reinforcement bar. This arrangement does not permit for a particularly secure connection between the stop member 54 and the aperture in the reinforcement bar 26, which can lead to weakness and/or total failure of the retention arrangement. In addition, the stop elements of the Quasius system are made of steel and, therefore, do not recover from bending that may result from the application of strong displacement forces against the slats. The stop elements' failure to recover from bending could produce an obstruction in the guide tracks, thereby negatively impacting the movement of the slats during subsequent attempted normal operation of the system. To avoid such obstruction, the stop elements may require replacement, which, if not performed properly and quickly, could reduce the usefulness of the system.

Another slat dislodgement prevention approach is disclosed in U.S. Pat. No. 5,657,805 issued to Magro. The Magro patent discloses the use of endlocks 48, which are fastened to the ends of the slats using external fasteners, which, again, is a time consuming exercise and, consequently, adds unnecessarily to the cost of manufacture. Furthermore, the fasteners can loosen over time due to vibrations associated with deployment and retraction of the system as well as wind and other external forces.

Another slat retention apparatus is disclosed in U.S. Pat. No. 5,253,694 to Bernardo. The Bernardo apparatus discloses a slat end retainer which is attached via fasteners to the ends of one or more slats of a rolling shutter system. These end retainers are, like the retainer of Magro, attached using manual fasteners (3 screws or rivets), which adds to the cost of manufacture and which can loosen over time, defeating the purpose of the invention.

Another slat dislodgement prevention approach is disclosed in German Patent Application Publication No. DE 2709029A1. Such publication describes a rolling shutter that includes a guide track having one or more stems extending perpendicularly from respective shanks of the track. The slats of the shutter system have matching recesses to accommodate the extending stem(s) while leaving room for play. While the system described in the German publication provides a mechanism for reducing the likelihood of slat dislodgement without the need for stop ends to be inserted in the slats, such system requires the slats to operate integrally with the perpendicularly oriented guide rail stems. However, the guide rail may not be perfectly vertical due to variations in normal architectural tolerances in the building to which the guide rail is attached. As a result, the guide rail stem may slightly obstruct the deployment of the slats, particularly when the shutter system is used on a daily basis for, e.g., security and privacy reasons.

Therefore, a need exists for a shutter system and barrier assembly for use in connection therewith that substantially reduces the likelihood of slat dislodgement in the presence of severe displacement forces without requiring the use of external fasteners, which can work loose over time and which are time consuming and labor intensive to install.

### BRIEF DESCRIPTION OF THE DRAWINGS

FIG. 1 is cross-sectional side elevational view of an installed shutter system of the type in connection with which the instant invention is adapted to be employed, installed in a building in a partially deployed configuration to cover an opening in a building.

FIG. 2A is a right perspective view of a slat end retention plug in accordance with this invention.

FIG. 2B is a left perspective view of the slat end retention plug shown in FIG. 2A.

FIG. 2C is a right perspective exploded view of the slat end retention plug shown in FIG. 2A, and the slat before the slat end retention plug and the slat are plugged together.

FIGS. 3 through 6 are a top cross-sectional plan view of alternative embodiments of the invention taken along lines 3 through 6 of FIG. 1.

FIGS. 7 through 10 show the slot retention plug of the instant invention fastened to shutter slats using a variety of punch techniques.

### DETAILED DESCRIPTION OF PREFERRED EMBODIMENTS

Generally, the present invention is an improvement to a rolling shutter system/barrier assembly for use in connection therewith for covering an opening in wall of a building. The shutter system includes a mounting assembly and a retractable/deployable barrier assembly. The mounting assembly includes at least one pair of guide tracks that are mountable to the wall of the building on opposing sides of the opening. Each guide track includes inner surfaces that define a guide channel. Two of the track's inner surfaces oppose one another and at least one of the two, opposing, inner surfaces includes one or more protruding members that extend into the guide channel.

The shutter assembly includes a series of interlocking slats. The slats are constrained for vertical movement within the guide rails by a pair of slat retention plugs 10, one mounted at each of the left and right ends of one or more of slats 20. Each plug 10 is sized and shaped to fit into an end of one of the slats 20 and within channel 24 of guide rails 22. Plugs 10 include a tapered section 12 and an enlarged end section 14, forming a shoulder 16 at the intersection thereof. Each of the guide rails 22 define projecting members 26, which protrude from one or both of the interior sidewalls 28A, 28B of guide tracks 22 so as to occupy a portion of channels 24.

Each plug 10 has a central portion 18 having an outer peripheral surface shape which corresponds generally to the interior surface shape of slat 20. An enlarged stop member 19 is formed at the distal end of plug 10, and forms a shoulder 21.

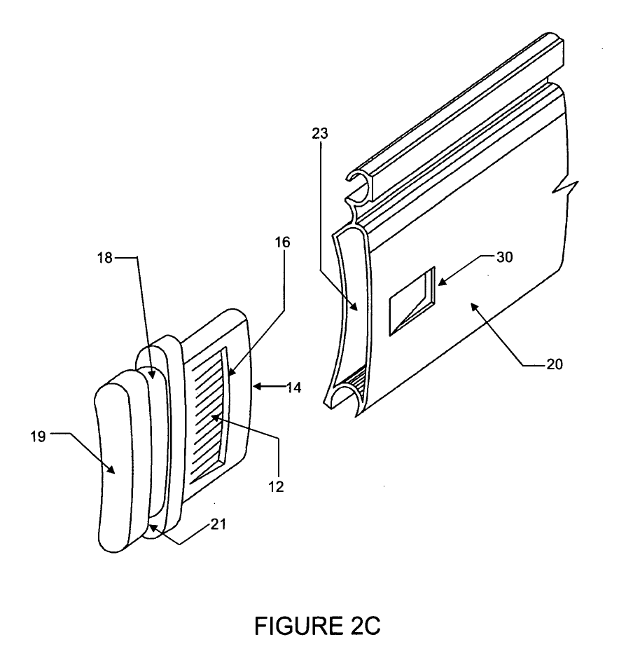

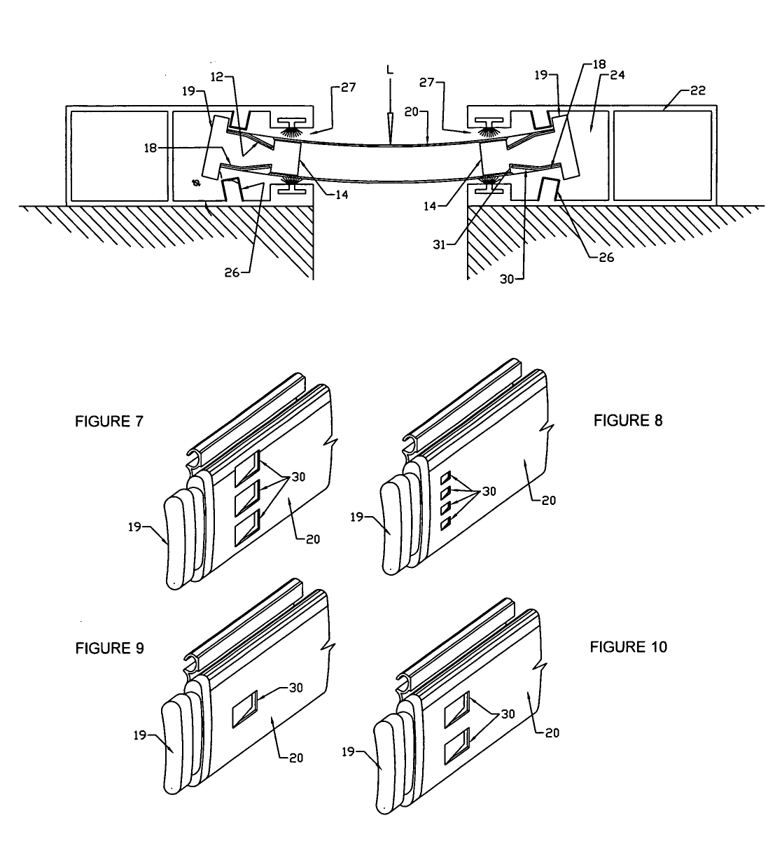

During assembly of the slats 20 and plugs 10, a plug 10 is inserted into the open end 23 of slat 20, as shown in FIGS. 2C. In order to securely attach the plugs 10 to the slats 20 and render the plug non-removable therefrom, a punch press or other mechanism is employed to create in part one or more attachment tabs 30, as shown in FIGS. 2C through 10. Tabs 30 are created by applying pressure over specified areas of one or more of the slats 20 in the barrier. The tabs 30 are created by tearing/cutting away a portion of the material of slat 20 corresponding to the tab or tabs being created, where the tabs 30 nest against or mate with a portion of tapered section 12 of plugs 10. The tabs 30 can also be a stamped cutout formed in a wall of the slat 20. Ends 31 of tabs 30 engage shoulders 16 of plugs 10 to prevent removal of plugs 10 from the slats 20.

By providing a shutter system and barrier assembly in this manner, the present invention reduces the likelihood of slat dislodgement in the presence of strong displacement forces, such as wind forces and projectile impact forces that result from strong tropical storms, typhoons or hurricanes. With the present invention, fabrication of the slats and the guide tracks can proceed using conventional fabrication processes. For example, the guide tracks and slats of the present invention, including the stop members 26 formed in the channels 24 of guide rails 22, may be fabricated using the same extrusion processes that are used to make existing guide tracks and slats.

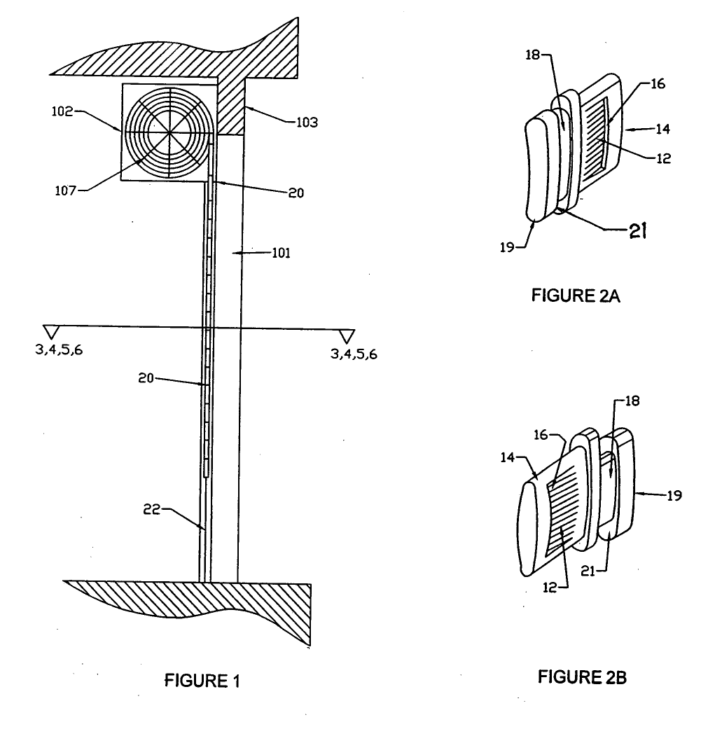

The present invention can be more fully understood with reference to FIGS. 1-10, in which like reference numerals designate like items. FIG. 1 is a cut-away side elevational view of an installed shutter system 100 in a partially deployed configuration to cover an opening 101 in a building. The depicted shutter system 100 includes a retractable and deployable barrier assembly, a mounting/housing assembly 102, and a motorized roller 107 (shown in phantom in FIG. 1). The barrier assembly preferably includes a series of interlocking horizontal slats 20 that deploy from and retract into, as applicable, the roller 107 and/or its associated housing 108. When deployed, the slats 20 cover the opening 101 in the wall 103 of the building such that the inside surfaces of the slats 20, which together define an inside surface of the barrier assembly, are proximate the opening 101 and the outside surfaces of the slats 20, which together define an outside surface of the barrier assembly, face the outdoors and are positioned to receive any externally-generated displacement forces that may be exerted against the barrier assembly. The motorized roller 107 is constructed in accordance with conventional techniques to retain the slats 20 in a rolled configuration until deployment is desired and to deploy the slats 20 upon activation by a user such that the slats 20 cover the opening 101 in the wall 103 to which the motor housing 108 is mounted.

Each of the slats 20 is preferably fabricated in a conventional manner from high strength aluminum alloy (e.g., 6063-T5 or 6063-T6 extruded aluminum alloy manufactured by Aluminio Dominicano of Santo Domingo, Dominican Republic or various other manufacturers), steel, high strength plexiglass, or any other material capable of withstanding a desired level of displacement forces (e.g., those associated with wind speeds up to approximately 155 miles per hour). When deployed, the series of slats 20 have a length larger than the wall opening 101 that the slats 20 are intended to shield to prevent, or at least substantially impede, any projectiles or other displacement forces from entering the opening 101.

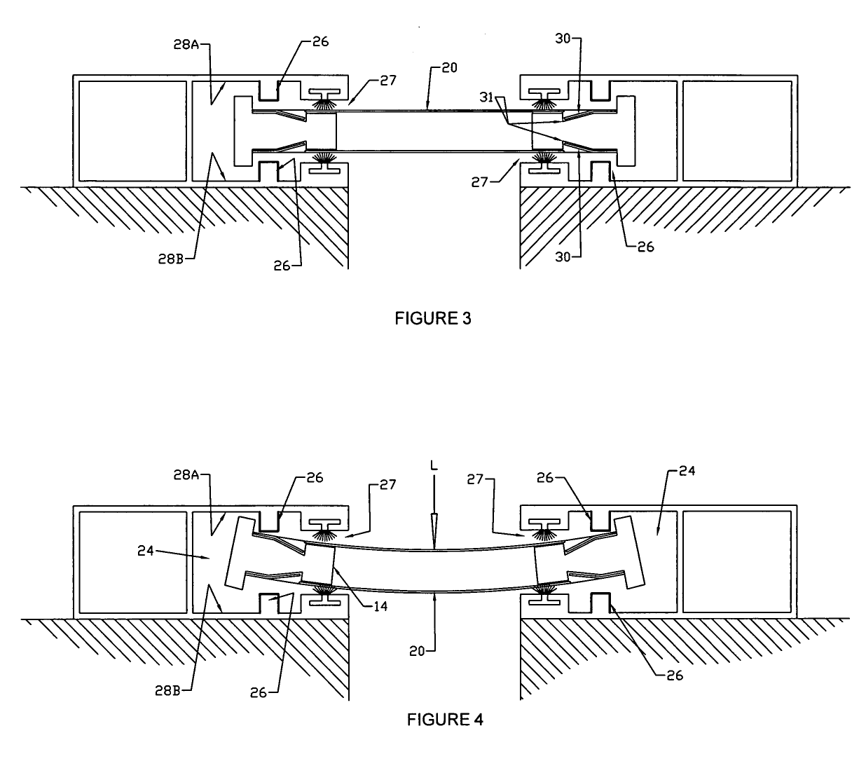

The mounting assembly preferably comprises at least one pair of guide tracks 22 that are mountable to opposing sides of the wall opening 101. Each guide track 22 is preferably fabricated from high strength aluminum alloy (e.g., 6063-T5 or 6063-T6 extruded aluminum alloy) using conventional extrusion processes. During installation, each guide track 110 is mounted to the wall 103 using appropriate conventional fasteners (e.g., TAPCON concrete screws when the guide tracks 22 are secured to a concrete block wall 103). The guide tracks 22, the slats 20 of the shutter system 100 are described in more detail with respect to FIGS. 3-10.

FIGS. 3-4 are partial detailed cross-sectional top views of left and right guide tracks 22, and a slat 105 of the shutter system 100 of FIG. 1 in accordance with a first embodiment of the present invention. As shown, the guide track 22 includes inner surfaces 28A-28B that together defines opposing sidewalls of a guide channel 24 of track 22. With such construction, the guide channel 24 has an open end 27 that permits the slats 20 to extend out of the track 22 and across the wall opening 101. Thus, the guide track 22 functions in concert with plugs 10 to maintain the slats 20 of the barrier assembly in a desired position relative to the wall opening 101.

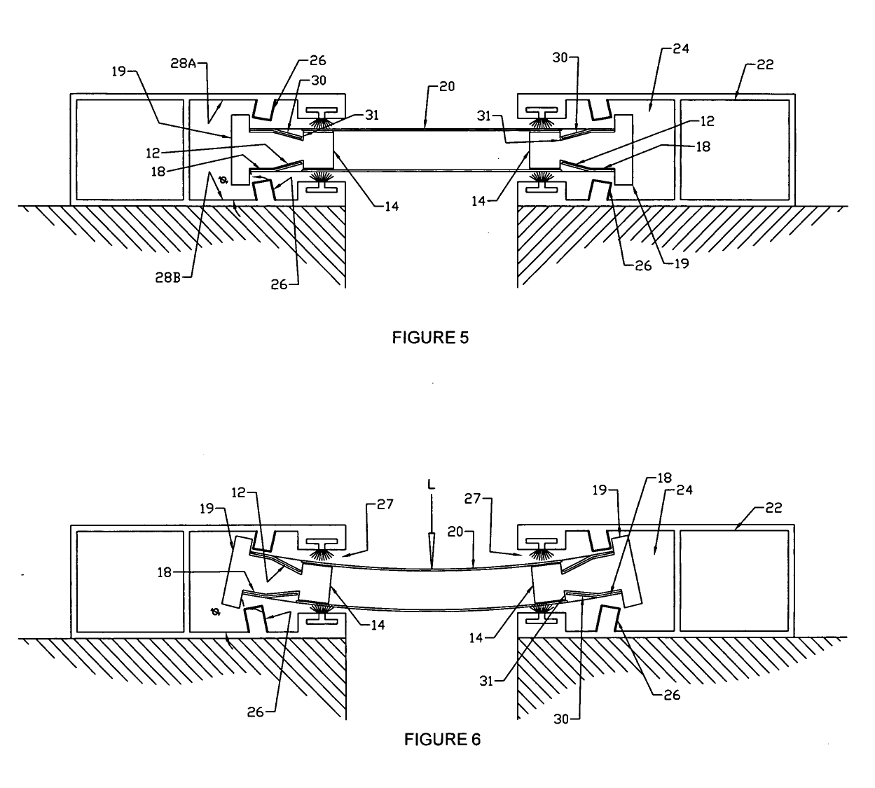

In addition to assisting in defining the guide track's guide channel 24, one or both opposing inner surfaces 28A, 28B of the guide track 22 include one or more protruding stop members 26 (two shown, although only one is necessary to accomplish the purpose of strengthening the shutter assembly against external forces (i.e. those imposed from the top of the drawing in FIG. 4)). In the event only one stop member 26 is used in such an application (i.e. to guard against externally applied loading), the lower stop member 26 in FIGS. 3 and 4 may be deleted. Each stop member 26 extends into the guide channel 24. In the embodiment shown in FIGS. 3 and 4, stop members 26 extend into channel 24 essentially perpendicularly to sidewalls 28A, 28B. In the embodiment shown in FIGS. 5 and 6, all structural configurations remain the same, with the exception that the stop members 261 angle away from the guide channel's open end 27. The angle at which the stop member(s) 26 extend into the track's guide channel 24 may be any angle in the range of about 30 degrees to about 89 degrees, but preferably comprise an angle in the range of about 45 degrees to about 75 degrees. The angle at which the stop member(s) 26 extend into the guide channel 24 is preferably determined by measuring the angle (θ) formed between the inner surface 28A, 28B of the guide track 22 from which the stop member 26 extends and an inner, angled surface 27 of the stop member 26.

The amount that the protruding member 26 extends into the guide track's channel 24 depends on a variety of factors, including, without limitation, the size and shape of enlarged end 19, the location of the member 26 in the channel, the amount of slat deflection permitted prior to engagement between shoulder 21 and stop member 26, and characteristics of the materials, channel width, and building height. In a preferred embodiment, the stop member 26 has a length in the range of approximately ¼ inches to ½ inches (approximately 6.35 millimeters to 12.7 millimeters) and extends into the guide channel 24 in the range of approximately 3/16 inches to 7/16 inches (approximately 4.7 millimeters to approximately 11.2 millimeters).

As can be seen in FIGS. 4 and 6, when an external load L (such as wind loading, a projectile or an intruder) is imposed upon slats 20, the slats deflect. This deflection causes the ends of slats 20, and consequently the plugs 10 which are securely fastened thereto, to translate toward the building opening 101. This in turn causes shoulders 21 of plugs 10 to engage the stop members 26, 26¹ (as the case may be), thereby prohibiting slats 20 from deflecting any further. This, in turn, prevents slats 20 from being dislodged from channels 24. The same would occur as to forces L exerted on the interior (building) side of slats 20 so long as the lower stop members 26 shown in FIGS. 4 and 6 are present.

As described above, the present invention encompasses a shutter system and associated barrier assembly for use in protecting building wall openings from damage resulting from exertion of large displacement forces, such as wind forces exerted during thunderstorms, tropical storms, hurricanes, tornados or other events. The shutter system and barrier assembly of the present invention reduce the likelihood that strong displacement forces exerted against the slats and connecting members of the barrier assembly will dislodge the slats from the mounting assembly, without requiring the fabrication complexities of some prior art slat dislodgement mitigation solutions. With the present invention, fabrication of slats of the barrier assembly and guide tracks of the shutter system's mounting assembly can proceed using conventional fabrication processes. In addition, by incorporating stop members 26 and plugs 10, the present invention provides cost effective and efficient slat dislodgement protection while mitigating the likelihood of slat obstruction during deployment and retraction of the slats.

In the foregoing specification, the present invention has been described with reference to specific embodiments. However, one of ordinary skill in the art will appreciate that various modifications and changes may be made without departing from the spirit and scope of the present invention as set forth in the appended claims. For example, various combinations of stop members 26, 26¹ and corresponding mating surfaces on plug 10, such as shoulder 21, are contemplated to be within the scope of my invention. For instance, the guide track may be fabricated to include multiple stop members and the plugs may be fabricated to include multiple corresponding shoulders or recesses to achieve a desired reduction in the likelihood of slat dislodgement. In addition, plugs 10 may be incorporated in only some, but not all, of the slats 20 (e.g., only in those slats that are centrally located over the wall opening 101 when the barrier assembly is fully deployed) depending on a desired amount of slat dislodgement reduction or a determination of which slats are more likely to be dislodged when the barrier assembly is fully deployed and displacement forces are applied. Further, the roller 107 that retains the slats 20 of the barrier assembly of FIG. 1 may be spring-loaded instead of motorized to facilitate manual deployment and retraction of the barrier assembly. Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all of the claims. As used herein and in the appended claims, the terms “comprises,∞ “comprising” or any other variation thereof is intended to refer to a non-exclusive inclusion, such that a process, method, apparatus, or article of manufacture that comprises a list of elements does not include only those elements in the list, but may include other elements not expressly listed or inherent to such process, method, apparatus, or article of manufacture.

I claim:

1. In a shutter system for covering an opening in a wall of a building, the shutter system comprising:
a mounting assembly that includes at least one pair of guide tracks, each pair of guide tracks being mountable to the building on opposing sides of the opening, each guide track including a plurality of inner surfaces that define a guide channel, two of the inner surfaces opposing one another and at least one of said two opposing inner surfaces including at least one stop member that extends into the guide channel; and
a barrier assembly that includes a plurality of interlocking flexible slats, the barrier assembly comprising:
at least one slat retention plug connected to an end of one of said slats of said barrier assembly by at least a first retention tab in a wall of said slat, said plug adapted to be slidingly engaged within one of said guide channels, said plug defining a shoulder which engages said at least one stop member upon deflection of said slat of a predetermined magnitude.

2. The shutter system of claim 1, further comprising at least a second retention tab being formed in said slat wall to retainingly engage the at least one plug within the slat.

3. The shutter system of claim 2, wherein the second retention tab is disposed on substantially an opposite side of the slat from the first retention tab.
